(19) United States
(12) Patent Application Publication
(10) Pub. No.: US 2025/0137773 A1
(43) Pub. Date: May 1, 2025

(54) FILM THICKNESS MEASUREMENT DEVICE

(71) Applicant: INDUSTRIAL TECHNOLOGY RESEARCH INSTITUTE, Hsinchu (TW)

(72) Inventors: Shih-Hsiang LAI, New Taipei City (TW); Fu-Cheng YANG, Hsinchu County (TW); Fu-Ching TUNG, Hsinchu City (TW); Hsuan-Fu WANG, Hsinchu City (TW); Po-Chun YEH, Taichung City (TW)

(73) Assignee: INDUSTRIAL TECHNOLOGY RESEARCH INSTITUTE, Hsinchu (TW)

(21) Appl. No.: 18/539,069

(22) Filed: Dec. 13, 2023

(30) Foreign Application Priority Data
Oct. 25, 2023 (TW) 112140752

(51) Int. Cl. G01B 11/06; G01N 21/21; G01N 21/84

(52) U.S. Cl. CPC G01B 11/0641; G01N 21/211; G01N 21/8422; G01N 2021/213

(57) ABSTRACT

A film thickness measurement device includes a spectroscopic ellipsometer, and the spectroscopic ellipsometer includes a projection module and a light receiving module. The projection module is configured to project a multi-wavelength polarized light onto a thin film. The projection module includes a light source and a polarization state generator. The light receiving module includes a polarization analyzer and an optical detector. The polarization analyzer is configured to screen out a multi-wavelength polarized reflection light according to reflection of the multi-wavelength polarized light by the thin film. The optical detector is configured to receive the multi-wavelength polarized reflection light. The optical detector includes at least one optical splitting unit, at least two optical filtering units and at least two optical detection units.

### CROSS-REFERENCE TO RELATED APPLICATIONS

This application claims priority under 35 U.S.C. § 119(a) on Patent Application No(s). 112140752 filed in Taiwan, R.O.C. on Oct. 25, 2023, the entire contents of which are hereby incorporated by reference.

### TECHNICAL FIELD

The present disclosure relates to a film thickness measurement device.

### BACKGROUND

An ellipsometer is a device for measuring the properties of thin films. It employs an optical measurement method based on ellipsometry to obtain parameters such as thickness, refractive index, and extinction coefficient of a thin film. Ellipsometers are widely used in various applications due to their non-destructive measurement method. However, a spectroscopic ellipsometer applied to conventional real-time film thickness measurement may encounter a problem of slow measuring speed, resulting in low efficiency that needs to be addressed.

### SUMMARY

According to one embodiment of the present disclosure, a film thickness measurement device includes a spectroscopic ellipsometer, and the spectroscopic ellipsometer includes a projection module and a light receiving module. The projection module is configured to project a multi-wavelength polarized light onto a thin film. The projection module includes a light source and a polarization state generator. The light receiving module includes a polarization analyzer and an optical detector. The polarization analyzer is configured to screen out a multi-wavelength polarized reflection light according to reflection of the multi-wavelength polarized light by the thin film. The optical detector is configured to receive the multi-wavelength polarized reflection light. The optical detector includes at least one optical splitting unit, at least two optical filtering units and at least two optical detection units. The at least one optical splitting unit is configured to split the multi-wavelength polarized reflection light into a first detection light and a second detection light with different wavelengths. The at least two optical filtering units respectively allow transmission of at least part of the first detection light and transmission of at least part of the second detection light. The at least two optical detection units is configured to respectively receive the first detection light and the second detection light.

### BRIEF DESCRIPTION OF THE DRAWINGS

FIG. 1 is a schematic view of a film thickness measurement device according to an embodiment of the present disclosure;

FIG. 2 is a schematic view of a film thickness measurement device according to another embodiment of the present disclosure;

FIG. 3 is a schematic view of an optical detector of the film thickness measurement device in FIG. 1;

FIG. 4 is a schematic view of a film formation apparatus according to an embodiment of the present disclosure;

FIG. 5 is a schematic view of an optical detector of a film thickness measurement device according to still another embodiment of the present disclosure;

FIG. 6 is a schematic view of an optical detector of a film thickness measurement device according to yet another embodiment of the present disclosure;

FIG. 7 is a schematic view of a film thickness measurement device according to a comparative embodiment of the present disclosure; and

FIG. 8 is a schematic view of a film thickness measurement device according to another comparative embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

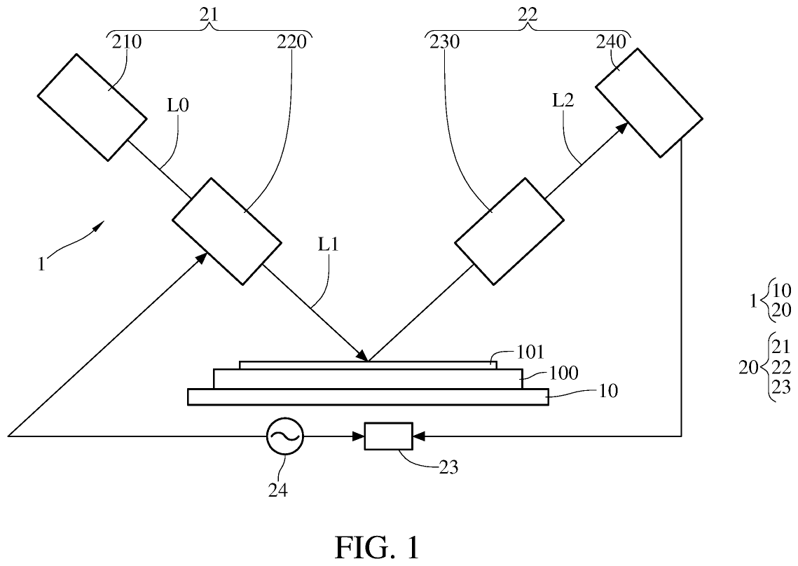

Please refer to FIG. 1 which is a schematic view of a film thickness measurement device according to an embodiment of the present disclosure. In this embodiment, a film thickness measurement device 1 includes a carrier 10 and a spectroscopic ellipsometer 20.

The carrier 10 is configured to support a substrate 100 with a thin film 101 formed thereon, or support a substrate 100 having a working surface for thin film disposition. The substrate 100 is, for example but not limited to, a glass board, a wafer or a circuit board. The thin film 101 is, for example but not limited to, a metal film, a polymer film or a composite material film.

As shown in FIG. 1, the spectroscopic ellipsometer 20 includes a projection module 21 and a light receiving module 22. The projection module 21 includes a light source 210 and a polarization state generator 220, and the light receiving module 22 includes a polarization analyzer 230 and an optical detector 240. The polarization state generator 220 is disposed corresponding to the light source 210, the polarization analyzer 230 is disposed corresponding to the carrier 10, and the optical detector 240 is disposed corresponding to the polarization analyzer 230.

The projection module 21 is configured to project a multi-wavelength polarized light L1 onto a thin film. Specifically, the light source 210 is configured to emit a multi-wavelength light L0 which is allowed to pass through the polarization state generator 220, and the multi-wavelength light L0 is modulated by the polarization state generator 220 to be polarized, such that the multi-wavelength light L0 is converted into multi-wavelength polarized light L1 projecting onto the thin film 101.

The light receiving module 22 is configured to receive a reflection light generated be reflection of the multi-wavelength polarized light L1 by the thin film 101, and the polarization analyzer 230 is configured to screen out a multi-wavelength polarized reflection light L2 according to reflection of the multi-wavelength polarized light L1 by the thin film 101. Specifically, the multi-wavelength polarized light L1 reaching the thin film 101 is reflected and then passes through the polarization analyzer 230. The polarization analyzer 230 reflects all but specific polarization of the multi-wavelength polarized light L1 so as to screen out the multi-wavelength polarized reflection light L2 with required polarization state. The optical detector 240 receives the multi-wavelength polarized reflection light L2 to obtain optical signals with different band-pass wavelengths. The received optical signals are transmitted to a calculation unit (not shown in the drawings) of the spectroscopic ellipsometer 20, and thus the calculation unit can calculate ellipsometric parameters Ψ and Δ.

In this embodiment, the spectroscopic ellipsometer 20 further includes a lock-in amplifier 23 coupled to the optical detector 240, and the lock-in amplifier 23 is coupled to the polarization state generator 220 through a source 24 of synchronous signals. Specifically, the polarization state generator 220 may be a photoelastic modulator (PEM). The multi-wavelength light L0 provided by the light source 210 is input into the polarization state generator through a time-varying modulation signal, such that the polarization state generator can generate the multi-wavelength polarized light L1 with time-varying characteristics. The multi-wavelength polarized light L1, reflected by the thin film 101, passes through the polarization analyzer 230 so as to screen out the multi-wavelength polarized reflection light L2. The multi-wavelength polarized reflection light L2 is received by the optical detector 240 so as to obtain multiple signals, containing time-varying modulation frequency and harmonic frequency, related to optical power variation. The signals are resolved by the lock-in amplifier 23 to determine the amplitude of the signals at required frequencies. The signals are calculated by algorithm so as to obtain several band-pass wavelengths Ψ and Δ. The band-pass Ψ and Δwavelengths are applied to a thin film interference model so as to determine thin film thickness.

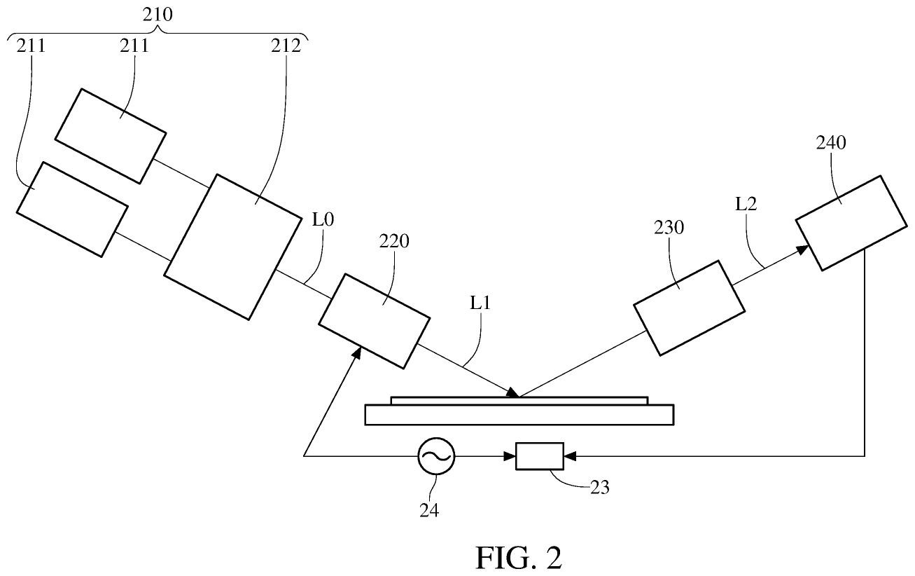

In FIG. 1, the light source 210 is a continuous-wave and broadband light source which can independently emit the multi-wavelength light L0, but the present disclosure is not limited thereto. Please refer to FIG. 2 which is a schematic view of a film thickness measurement device according to another embodiment of the present disclosure. The film thickness measurement device in FIG. 2 is similar to that in FIG. 1, and the difference between the two film thickness measurement devices is that the light source 210 of the film thickness measurement device in FIG. 2 may include multiple light emitting units, and the light emitting units emit simultaneously so as to provide the multi-wavelength light L0. As shown in FIG. 2, the light source 210 may include a plurality of light emitting units 211 which are independently disposed for light emission with different wavelengths. For example, one of the light emitting units 211 may be a single-wavelength light source emitting visible light or near-infrared light having a first wavelength, or a broadband light source emitting visible light or near-infrared light having the first wavelength. Another light emitting unit 211 may be a single-wavelength light source emitting visible light or near-infrared light having a second wavelength different from the first wavelength, or a broadband light source emitting visible light or near-infrared light having the second wavelength. The light source 210 may further include an optical combiner 212 configured to combine light emitted by the light emitting units 211 so as to generate the multi-wavelength light L0. The multi-wavelength light L0 is then transmitted to the polarization state generator 220, and thus the multi-wavelength polarized light L1 is obtained by the multi-wavelength light L0 passing through the polarization state generator 220.

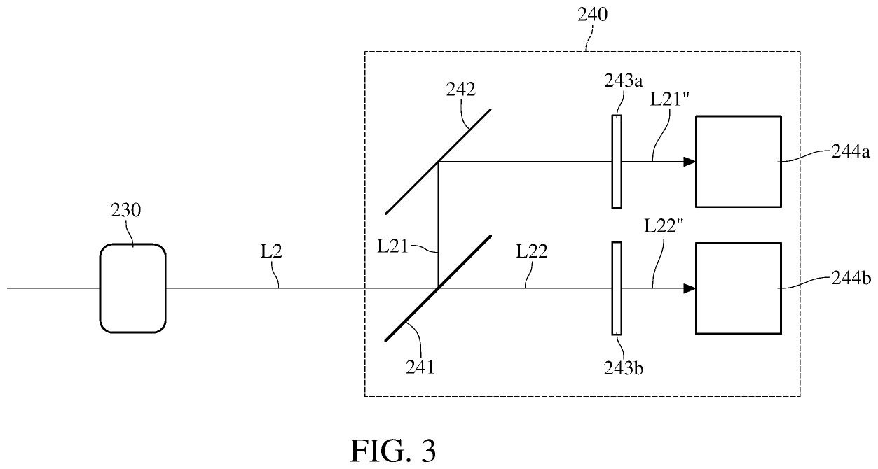

Please refer to FIG. 3 which is a schematic view of an optical detector of the film thickness measurement device in FIG. 1. In this embodiment, the optical detector 240 includes at least one optical splitting unit, at least one optical filtering unit and at least one optical detection unit. The optical detector 240 includes an optical splitting unit 241, a reflective mirror 242, an optical filtering unit 243a, an optical filtering unit 243b, an optical detection unit 244a and an optical detection unit 244b.

The optical splitting unit 241 is, for example but not limited to, a beam splitter mirror. After the polarization analyzer 230 screen out specific polarization of the multi-wavelength polarized reflection light L2, the optical splitting unit 241 is configured to split the multi-wavelength polarized reflection light L2 into a detection light L21 and a detection light L22 having different wavelength ranges. In this embodiment, the optical splitting unit 241 allows a wavelength range from 1260 nm to 1700 nm to pass therethrough and reflect a wavelength range from 750 nm to 1100 nm. Therefore, the detection light L21 is within 750 nm to 1100 nm, and the detection light L22 is within 1260 nm to 1700 nm.

The reflective mirror 242 is configured to fold an optical path of the detection light L21. The reflective mirror 242 is optionally provided. In a case where the optical detection units 244a, 244b are not necessary to be at the same side, the reflective mirror 242 may not be provided.

The optical filtering unit 243a is disposed corresponding to the optical splitting unit 241. The optical filtering unit 243a is, for example but not limited to, a band-pass filter allowing transmission of at least part of the detection light L21. In this embodiment, a transmission spectrum of the optical filtering unit 243a has a center wavelength of 1030 nm and a full width at half maximum (FWHM) of 10 nm. Therefore, a detection light L21″, generated by the detection light L21 passing through the optical filtering unit 243a, is within a band-pass wavelength range from 1020 nm to 1040 nm, and the detection light L21″ includes optical signals with required polarization state.

The optical detection unit 244a is disposed corresponding to the optical filtering unit 243a. The optical detection unit 244a is, for example but not limited to, a photodiode or a photomultiplier tube configured to receive the detection light L21″.

The optical filtering unit 243b is disposed corresponding to the optical splitting unit 241. The optical filtering unit 243b is, for example but not limited to, a band-pass filter allowing transmission of at least part of the detection light L22. In this embodiment, a transmission spectrum of the optical filtering unit 243b has a center wavelength of 1350 nm and a FWHM of 12 nm. Therefore, a detection light L22″, generated by the detection light L22 passing through the optical filtering unit 243b, is within a band-pass wavelength range from 1338 nm to 1362 nm, and the detection light L22″ includes optical signals with required polarization state.

The optical detection unit 244b is disposed corresponding to the optical filtering unit 243b. The optical detection unit 244b is, for example but not limited to, a photodiode or a photomultiplier tube configured to receive the detection light L22″.

The spectroscopic ellipsometer 20 may obtain a set of ellipsometric parameters Ψ and Δ according to the optical signals obtained by the detection light L21″ received by the optical detection unit 244a. The spectroscopic ellipsometer 20 may obtain another set of ellipsometric parameters Ψ and Δ according to the optical signals obtained by the detection light L22″ received by the optical detection unit 244b. The thickness of the thin film 101 can be determined based on these two sets of ellipsometric parameters. More specifically, in a case where the wavelength of the detection light, the angle of incidence of the detection light, the refractive index of the thin film 101, and the extinction coefficient of the thin film 101 are known values, Ψ and Δ may be represented as a function of the thickness (d) of the thin film 101; that is, the following conditions are satisfied: Ψ=f₁(d); and Δ=f₂(d).

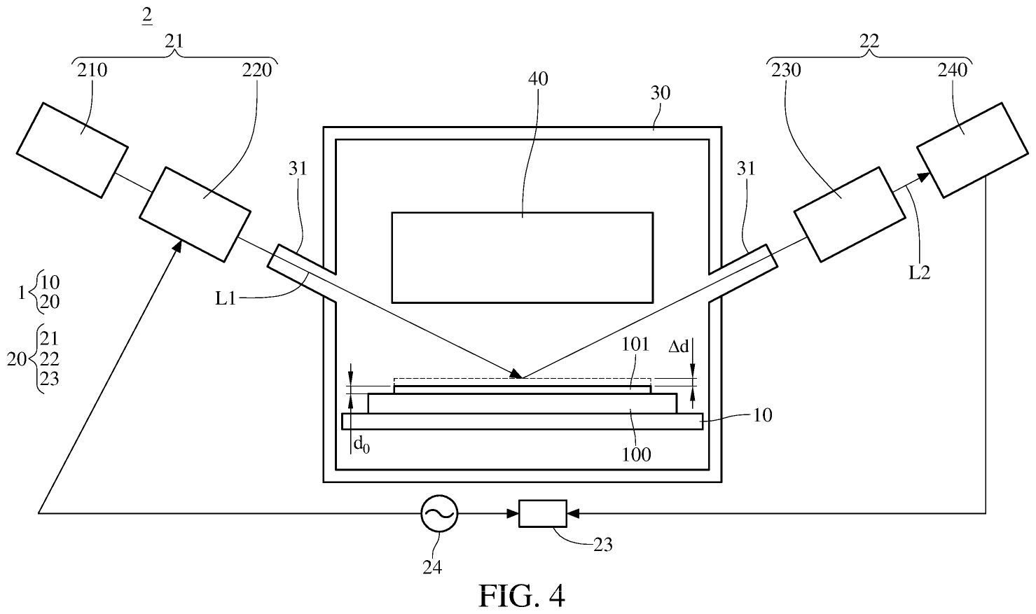

According to the present disclosure, the film thickness measurement device may be applied to a film formation apparatus to achieve in situ thickness measurement. FIG. 4 is a schematic view of a film formation apparatus according to an embodiment of the present disclosure. The film formation apparatus 2 may include a processing chamber 30 and the film thickness measurement device 1 in FIG. 1. A processing unit 40 and the carrier of the film thickness measurement device 1 may be accommodated in the processing chamber 30.

The processing unit 40 is, for example but not limited to, a mechanism or a device which may perform plasma enhanced chemical vapor deposition (PECVD), sputtering, atomic layer deposition (ALD) or atomic layer chemical vapor deposition (ALCVD). The carrier 10 may be served as a platform for supporting the substrate 100 during thin film deposition process.

The spectroscopic ellipsometer 20 of the film thickness measurement device 1 is disposed outside the processing chamber 30. Specifically, the projection module 21 of the spectroscopic ellipsometer 20 is disposed at one side of the processing chamber 30, and the multi-wavelength polarized light L1 may travel into the processing chamber 30 through a cavity 31 of the processing chamber 30. The light receiving module 22 of the spectroscopic ellipsometer 20 is disposed at opposite side of the processing chamber 30. The multi-wavelength polarized reflection light L2, screened out by the polarization analyzer 230 through which the multi-wavelength polarized light L1 reflected by the thin film 101 on the substrate 100 passes, may exit the processing chamber 30 through the other cavity 31 thereof. The multi-wavelength polarized reflection light L2 traveling out of the processing chamber 30 is received by the optical detector 240.

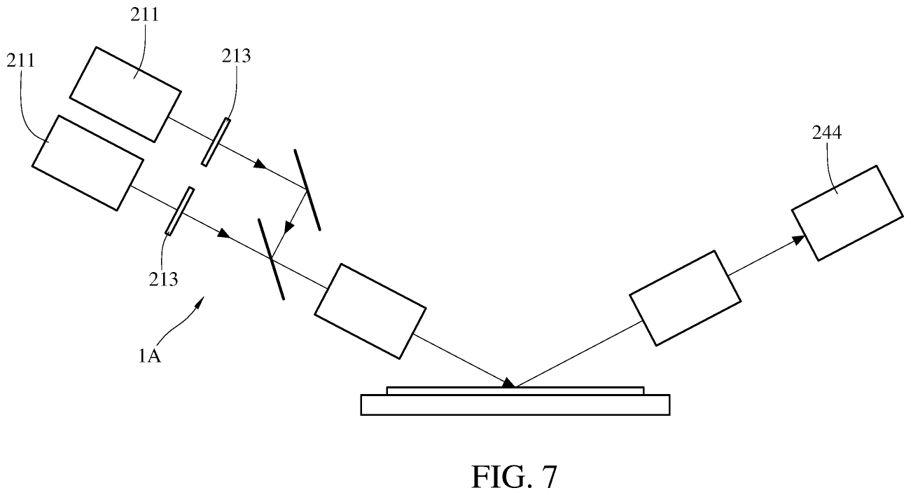

Compared to the conventional film thickness measurement devices including ellipsometer, the film thickness measurement device according to the present disclosure is advantageous in improving measurement efficiency. FIG. 7 is a schematic view of a film thickness measurement device according to a comparative embodiment of the present disclosure. The film thickness measurement device 1A according to the comparative embodiment includes a light source including multiple light emitting units 211 and multiple shutters 213. The shutter 213 is, for example but not limited to, an aperture with variable size. The shutter 213 is configured to allow light emitted by the emitting unit 211 to pass therethrough. Also, the optical detector of the film thickness measurement device 1A includes single optical detection unit 244.

A method of measuring film thickness by using the film thickness measurement device 1A includes a step of sequentially emitting lights with different wavelengths, instead of emitting multi-wavelength light as depicted in FIG. 1 and FIG. 2. Specifically, when the film thickness is to be measured, one shutter 213 corresponding to one light emitting unit 211 is opened to allow monochromatic light (e.g., violet light) emitted by this light emitting unit 211 to pass therethrough, and meanwhile another shutter 213 corresponding to another light emitting unit 211 is closed to reflect monochromatic light (e.g., infrared light) emitted by another light emitting unit 211. Said monochromatic light is reflected by the thin film and then received by the optical detection unit 244, thereby generating a set of ellipsometric parameters Ψ and Δ. Next, the another shutter 213 corresponding to the another light emitting unit 211 is opened, and meanwhile the one shutter 213 corresponding to the one light emitting unit 211 is closed. Said monochromatic light is reflected by the thin film and then received by the optical detection unit 244, thereby generating another set of ellipsometric parameters Ψ and Δ.

Accordingly, to determine film thickness, the film thickness measurement device 1A have to implement multiple measuring steps to obtain multiple sets of ellipsometric parameters. Relatively, the film thickness measurement device 1 in FIG. 1 or FIG. 2 can determine film thickness by implementing single measuring step to obtain multiple sets of ellipsometric parameters, thereby enhancing measuring efficiency.

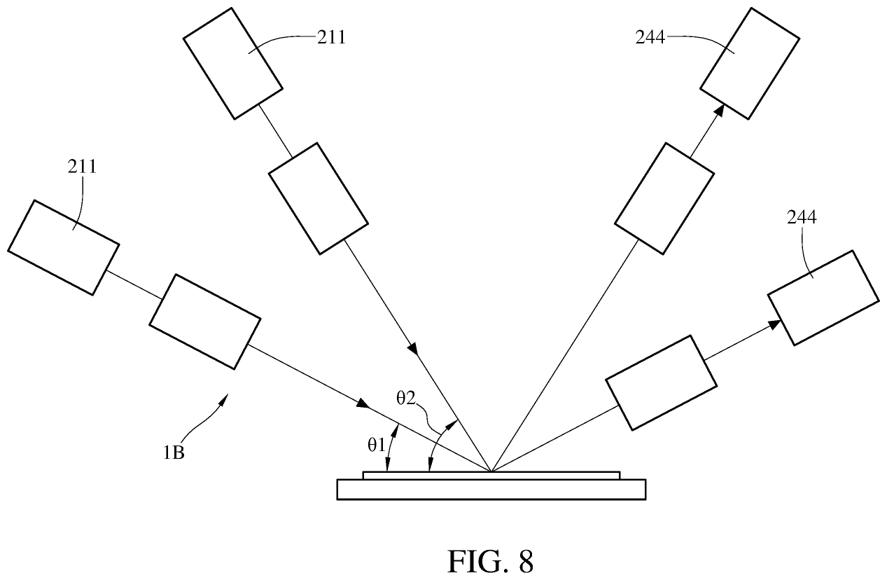

Furthermore, compared to the conventional film thickness measurement devices including ellipsometer, the film thickness measurement device according to the present disclosure is applicable to achieve in situ thickness measurement. FIG. 8 is a schematic view of a film thickness measurement device according to another comparative embodiment of the present disclosure. The film thickness measurement device 1B according to another comparative embodiment includes a light source including multiple light emitting units 211 and an optical detector, and the optical detector includes multiple optical detection units 244. Lights emitted by the light emitting units 211 are projected onto the thin film at different angles θ1, θ2 of incidence. Lights emitted by the light emitting units 211 are reflected by the thin film and then received by respective optical detection units 244.

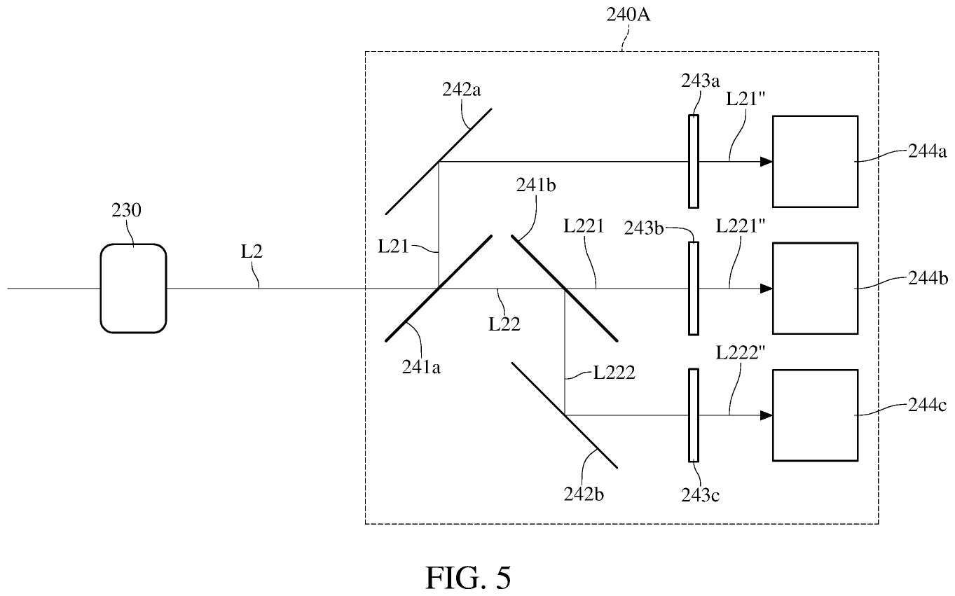

According to a film thickness measurement device of the present disclosure, the number of the optical splitting unit, the number of the optical filtering unit and the number of the optical detection unit are determined according to the number of unknown values among film refractive index, film extinction coefficient and film thickness in the ellipsometric parameters. Specifically, the optical detector of the film thickness measurement device of the present disclosure is not limited to one optical splitting unit, two optical filtering units and two optical detection units as shown in FIG. 3. FIG. 5 is a schematic view of an optical detector of a film thickness measurement device according to still another embodiment of the present disclosure. The optical detector 240A according to one embodiment of the present disclosure includes an optical splitting unit 241a, an optical splitting unit 241b, a reflective mirror 242a, a reflective mirror 242b, an optical filtering unit 243a, an optical filtering unit 243b, an optical filtering unit 243c, an optical detection unit 244a, an optical detection unit 244b and an optical detection unit 244c. The optical detector 240A may be configured to replace the optical detector 240 in FIG. 1 or FIG. 2.

Please refer to FIG. 1 and FIG. 5, after the polarization analyzer 230 screens out the multi-wavelength polarized reflection light L2 with required polarization state, the optical splitting unit 241a of the optical detector 240A is configured to split the multi-wavelength polarized reflection light L2 into a detection light L21 and a detection light L22 having different wavelength ranges. In this embodiment, the optical splitting unit 241a allows a wavelength range from 1260 nm to 1700 nm to pass therethrough and reflect a wavelength range from 750 nm to 1100 nm. Therefore, the detection light L21 is within 750 nm to 1100 nm, and the detection light L22 is within 1260 nm to 2000 nm.

The reflective mirror 242a is configured to fold an optical path of the detection light L21. The reflective mirror 242a is optionally provided.

Referring to FIG. 5, in this embodiment, the optical filtering unit 243a is disposed corresponding to the optical splitting unit 241a, and the reflective mirror 242a is configured to fold the optical path of the detection light L21, while the reflective mirror 242a may be omitted. The optical filtering unit 243a allows transmission of at least part of the detection light L21. In this embodiment, a transmission spectrum of the optical filtering unit 243a has a center wavelength of 1030 nm and a FWHM of 10 nm. Therefore, a detection light L21″, generated by the detection light L21 passing through the optical filtering unit 243a, is within a band-pass wavelength range from 1020 nm to 1040 nm, and the detection light L21″ includes optical signals with required polarization state.

The optical detection unit 244a is disposed corresponding to the optical filtering unit 243a. The optical detection unit 244a is configured to receive the detection light L21″.

The optical splitting unit 241b is configured to further split the detection light L22 into a detection light L221 and a detection light L222 having different wavelength ranges. In this embodiment, the optical splitting unit 241b allows a wavelength range from 1550 nm to 2000 nm to pass therethrough and reflect a wavelength range from 1260 nm to 1450 nm. Therefore, the detection light L221 is within 1550 nm to 2000 nm, and the detection light L222 is within 1260 nm to 1450 nm.

The optical filtering unit 243b is disposed corresponding to the optical splitting unit 241b. The optical filtering unit 243b allows transmission of at least part of the detection light L221. In this embodiment, a transmission spectrum of the optical filtering unit 243b has a center wavelength of 1550 nm and a FWHM of 12 nm. Therefore, a detection light L221″, generated by the detection light L221 passing through the optical filtering unit 243b, is within a band-pass wavelength range from 1550 nm to 1562 nm, and the detection light L221″ includes optical signals with required polarization state.

The optical detection unit 244b is disposed corresponding to the optical filtering unit 243b. The optical detection unit 244b is configured to receive the detection light L221″.

The reflective mirror 242b is configured to fold an optical path of the detection light L222. The reflective mirror 242b is optionally provided.

The optical filtering unit 243c is disposed corresponding to the optical splitting unit 241b. The optical filtering unit 243c allows transmission of at least part of the detection light L222. In this embodiment, a transmission spectrum of the optical filtering unit 243c has a center wavelength of 1350 nm and a FWHM of 12 nm. Therefore, a detection light L222″, generated by the detection light L222 passing through the optical filtering unit 243c, is within a band-pass wavelength range from 1338 nm to 1362 nm, and the detection light L222″ includes optical signals with required polarization state.

The optical detection unit 244c is disposed corresponding to the optical filtering unit 243c. The optical detection unit 244c is configured to receive the detection light L222″.

The detection lights L21″, L221″ and L222″ may have different wavelength ranges.

A spectroscopic ellipsometer including the optical detector 240A in FIG. 5 may be used to measure film thickness when film refractive index is unknown. In detail, a film formation apparatus, such as the film formation apparatus 2 in FIG. 4, may include the spectroscopic ellipsometer including the optical detector 240A so as to achieve in situ thickness measurement. Please refer to FIG. 4 and FIG. 5, after the thin film 101 with an initial thickness do has somewhat increased in a thickness Δd due to a film deposition process, the spectroscopic ellipsometer can measure a thickness d after the film deposition process, wherein d=d0+Δd.

In an application scenario of in situ thickness measurement, the refractive index and thickness of the thin film 101 may be both unknown. For example, when a silicon nitride film (thin film 101) with an initial thickness d0 is thickened to a thickness d by PECVD, a refractive index of the silicon nitride film with the thickness d may be different from that of the silicon nitride film with the initial thickness do due to a complex refractive index of the silicon nitride film. When an extinction coefficient of the thin film 101 is known and its refractive index as well as thickness are both unknown, the ellipsometric parameters Ψ and Δ, obtained by the spectroscopic ellipsometer, may be represented as a function of the refractive index (n) and the thickness (d) of the thin film 101; that is, the following conditions are satisfied: Ψ=f₁(n, d); and Δ=f₂(n, d). In this way, it may not be possible to obtain a unique solution by providing only two sets of ellipsometric parameters.

Accordingly, the spectroscopic ellipsometer may obtain a first set of ellipsometric parameters according to the optical signals obtained by the detection light L21″ received by the optical detection unit 244a. The spectroscopic ellipsometer may obtain a second set of ellipsometric parameters according to the optical signals obtained by the detection light L221″ received by the optical detection unit 244b. The spectroscopic ellipsometer may obtain a third set of ellipsometric parameters according to the optical signals obtained by the detection light L222″ received by the optical detection unit 244c. The thickness of the thin film 101 can be known from these three sets of ellipsometric parameters.

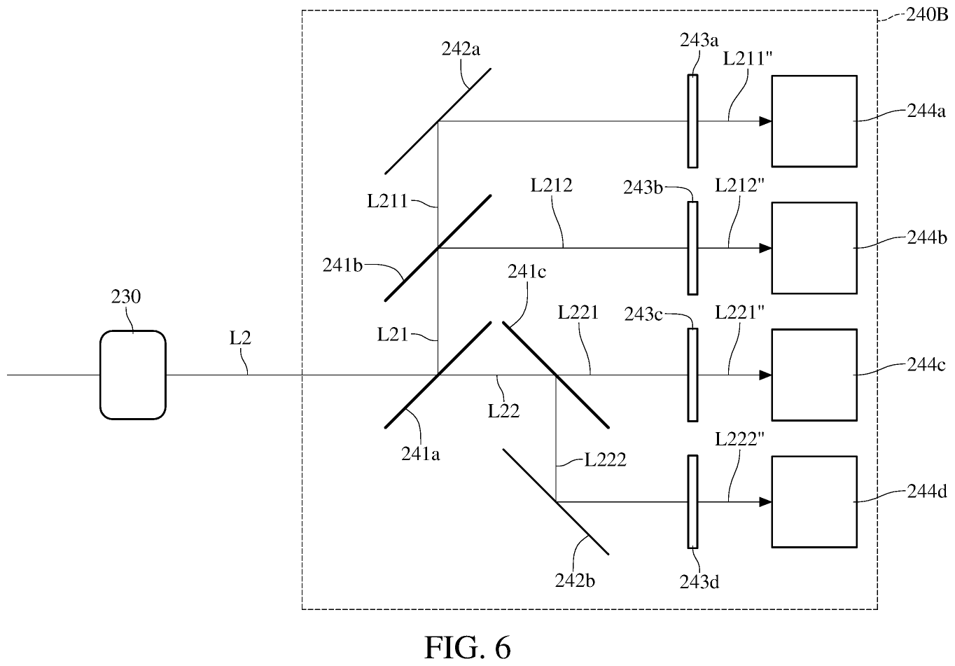

FIG. 6 is a schematic view of an optical detector of a film thickness measurement device according to yet another embodiment of the present disclosure. The optical detector 240B according to one embodiment of the present disclosure includes an optical splitting unit 241a, an optical splitting unit 241b, an optical splitting unit 241c, a reflective mirror 242a, a reflective mirror 242b, an optical filtering unit 243a, an optical filtering unit 243b, an optical filtering unit 243c, an optical filtering unit 243d, an optical detection unit 244a, an optical detection unit 244b, an optical detection unit 244c and an optical detection unit 244d. The optical detector 240B may be configured to replace the optical detector 240 in FIG. 1 or FIG. 2.

Please refer to FIG. 1 and FIG. 6, after the polarization analyzer 230 screens out the multi-wavelength polarized reflection light L2 with required polarization state, the optical splitting unit 241a of the optical detector 240B is configured to split the multi-wavelength polarized reflection light L2 into a detection light L21 and a detection light L22 having different wavelength ranges. In this embodiment, the optical splitting unit 241a allows a wavelength range from 1260 nm to 1700 nm to pass therethrough and reflect a wavelength range from 750 nm to 1100 nm. Therefore, the detection light L21 is within 750 nm to 1100 nm, and the detection light L22 is within 1260 nm to 1700 nm.

Referring to FIG. 6, the optical splitting unit 241b is configured to further split the detection light L21 into a detection light L211 and a detection light L212 having different wavelength ranges. In this embodiment, the optical splitting unit 241b allows a wavelength range from 1020 nm to 1550 nm to pass therethrough and reflect a wavelength range from 520 nm to 985 nm. Therefore, the detection light 211 is within 1020 nm to 1550 nm, and the detection light L212 is within 520 nm to 985 nm.

The reflective mirror 242a is configured to fold an optical path of the detection light L211. The reflective mirror 242a is optionally provided.

Referring to FIG. 6, in this embodiment, the optical filtering unit 243a is disposed corresponding to the optical splitting unit 241b, and the reflective mirror 242a is configured to fold the optical path of the detection light L211, while the reflective mirror 242a may be omitted. The optical filtering unit 243a allows transmission of at least part of the detection light L211. In this embodiment, a transmission spectrum of the optical filtering unit 243a has a center wavelength of 1030 nm and a FWHM of 10 nm. Therefore, a detection light L211″, generated by the detection light L211 passing through the optical filtering unit 243a, is within a band-pass wavelength range from 1020 nm to 1040 nm, and the detection light L211″ includes optical signals with required polarization state.

The optical detection unit 244a is disposed corresponding to the optical filtering unit 243a. The optical detection unit 244a is configured to receive the detection light L211″.

The optical filtering unit 243b is disposed corresponding to the optical splitting unit 241b. The optical filtering unit 243b allows transmission of at least part of the detection light L212. In this embodiment, a transmission spectrum of the optical filtering unit 243b has a center wavelength of 980 nm and a FWHM of 10 nm. Therefore, a detection light L212″, generated by the detection light L212 passing through the optical filtering unit 243b, is within a band-pass wavelength range from 970 nm to 985 nm, and the detection light L212″ includes optical signals with required polarization state.

The optical detection unit 244b is disposed corresponding to the optical filtering unit 243b. The optical detection unit 244b is configured to receive the detection light L212″.

The optical splitting unit 241c is configured to further split the detection light L22 into a detection light L221 and a detection light L222 having different wavelength ranges. In this embodiment, the optical splitting unit 241c allows a wavelength range from 1550 nm to 2000 nm to pass therethrough and reflect a wavelength range from 1000 nm to 1450 nm. Therefore, the detection light L221 is within 1550 nm to 2000 nm, and the detection light L222 is within 1000 nm to 1450 nm.

The optical filtering unit 243c is disposed corresponding to the optical splitting unit 241c. The optical filtering unit 243c allows transmission of at least part of the detection light L221. In this embodiment, a transmission spectrum of the optical filtering unit 243c has a center wavelength of 1550 nm and a FWHM of 12 nm. Therefore, a detection light L221″, generated by the detection light L221 passing through the optical filtering unit 243c, is within a band-pass wavelength range from 1550 nm to 1562 nm, and the detection light L221″ includes optical signals with required polarization state.

The optical detection unit 244c is disposed corresponding to the optical filtering unit 243c. The optical detection unit 244c is configured to receive the detection light L221″.

The reflective mirror 242b is configured to fold an optical path of the detection light L222. The reflective mirror 242b is optionally provided.

The optical filtering unit 243d is disposed corresponding to the optical splitting unit 241c. The optical filtering unit 243d allows transmission of at least part of the detection light L222. In this embodiment, a transmission spectrum of the optical filtering unit 243d has a center wavelength of 1350 nm and a FWHM of 12 nm. Therefore, a detection light L222″, generated by the detection light L222 passing through the optical filtering unit 243d, is within a band-pass wavelength range from 1338 nm to 1362 nm, and the detection light L222″ includes optical signals with required polarization state.

The optical detection unit 244d is disposed corresponding to the optical filtering unit 243d. The optical detection unit 244d is configured to receive the detection light L222″.

The detection lights L211″, L212″, L221″ and L222″ may have different wavelength ranges.

A spectroscopic ellipsometer including the optical detector 240B in FIG. 6 may be used to measure film thickness when both film refractive index and film extinction coefficient are unknown. In detail, a film formation apparatus, such as the film formation apparatus 2 in FIG. 4, may include the spectroscopic ellipsometer including the optical detector 240B so as to achieve in situ thickness measurement. Please refer to FIG. 4 and FIG. 6, in an application scenario of in situ thickness measurement, the refractive index, the extinction coefficient and the thickness of the thin film 101 may be all unknown. For example, when a GST (Germanium-antimony-tellurium) film (thin film 101) with an initial thickness d0 is thickened to a thickness d (d=d0+Δd) by ALD, if the GST film is extremely thin (e.g., under 100 nm), the composition of the GST film may not be Ge₂Sb₂Teₛ but GeₓSb_{y}Te_{z}, where each of x, y, and z is an arbitrary positive number. In such a case, an extinction coefficient of the GST film with the thickness d may be different from that of the GST film with the initial thickness d0. Furthermore, a refractive index of the GST film with the thickness d may be different from that of the GST film with the initial thickness do due to a complex refractive index of the GST film. Herein, the ellipsometric parameters Ψ and Δ, obtained by the spectroscopic ellipsometer, may be represented as a function of the refractive index (n), the extinction coefficient (k) and the thickness (d) of the thin film 101; that is, the following conditions are satisfied: Ψ=f₁(n, k, d); and Δ=f₂(n, k, d). In this way, it may not be possible to obtain a unique solution by providing only two or three sets of ellipsometric parameters.

Accordingly, the spectroscopic ellipsometer may obtain a first set of ellipsometric parameters according to the optical signals obtained by the detection light L211″ received by the optical detection unit 244a. The spectroscopic ellipsometer may obtain a second set of ellipsometric parameters according to the optical signals obtained by the detection light L212″ received by the optical detection unit 244b. The spectroscopic ellipsometer may obtain a third set of ellipsometric parameters according to the optical signals obtained by the detection light L221″ received by the optical detection unit 244c. The spectroscopic ellipsometer may obtain a fourth set of ellipsometric parameters according to the optical signals obtained by the detection light L222″ received by the optical detection unit 244d. The thickness of the thin film 101 can be known from these four sets of ellipsometric parameters.

The wavelength ranges of each optical splitting unit and each optical filtering unit mentioned above are only exemplary. The film thickness measurement device of the present disclosure can obtain ellipsometric parameters by selecting suitable wavelengths depending on film material.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A film thickness measurement device, comprising:
a spectroscopic ellipsometer, comprising:
a projection module, configured to project a multi-wavelength polarized light onto a thin film, wherein the projection module comprises a light source and a polarization state generator; and
a light receiving module, comprising a polarization analyzer and an optical detector, wherein the polarization analyzer is configured to screen out a multi-wavelength polarized reflection light according to reflection of the multi-wavelength polarized light by the thin film, and the optical detector is configured to receive the multi-wavelength polarized reflection light;
wherein, the optical detector comprises at least one optical splitting unit, at least two optical filtering units and at least two optical detection units, the at least one optical splitting unit is configured to split the multi-wavelength polarized reflection light into a first detection light and a second detection light with different wavelengths, the at least two optical filtering units respectively allow transmission of at least part of the first detection light and transmission of at least part of the second detection light, and the at least two optical detection units is configured to respectively receive the first detection light and the second detection light.

2. The film thickness measurement device according to claim 1, wherein the light source is a continuous-wave and broadband light source.

3. The film thickness measurement device according to claim 1, wherein the light source comprises a plurality of light emitting units which are independently disposed for light emission with different wavelengths, and the plurality of light emitting units emit light simultaneously to generate the multi-wavelength polarized light.

4. The film thickness measurement device according to claim 1, wherein the at least one optical splitting unit comprises a first optical splitting unit and a second optical splitting unit, the at least two optical filtering units comprises a first optical filtering unit, a second optical filtering unit and a third optical filtering unit, and the at least two optical detection units comprises a first optical detection unit, a second optical detection unit and a third optical detection unit,
the first optical splitting unit splits the multi-wavelength polarized reflection light into the first detection light and the second detection light with different wavelengths,
the second optical splitting unit is disposed corresponding to the first optical splitting unit and splits the second detection light into a third detection light and a fourth detection light with different wavelengths,
the first optical filtering unit allows transmission of at least part of the first detection light,
the second optical filtering unit allows transmission of at least part of the third detection light,
the third optical filtering unit allows transmission of at least part of the fourth detection light,
the first optical detection unit receives the first detection light,
the second optical detection unit receives the third detection light, and
the third optical detection unit receives the fourth detection light.

5. The film thickness measurement device according to claim 1, wherein the at least one optical splitting unit comprises a first optical splitting unit, a second optical splitting unit and a third optical splitting unit, the at least two optical filtering units comprises a first optical filtering unit, a second optical filtering unit, a third optical filtering unit and a fourth optical filtering unit, and the at least two optical detection units comprises a first optical detection unit, a second optical detection unit, a third optical detection unit and a fourth optical detection unit,
the first optical splitting unit splits the multi-wavelength polarized reflection light into the first detection light and the second detection light with different wavelengths,
the second optical splitting unit is disposed corresponding to the first optical splitting unit and splits the first detection light into a third detection light and a fourth detection light with different wavelengths,
the third optical splitting unit is disposed corresponding to the first optical splitting unit and splits the second detection light into a fifth detection light and a sixth detection light with different wavelengths,
the first optical filtering unit allows transmission of at least part of the third detection light,
the second optical filtering unit allows transmission of at least part of the fourth detection light,
the third optical filtering unit allows transmission of at least part of the fifth detection light,
the fourth optical filtering unit allows transmission of at least part of the sixth detection light,
the first optical detection unit receives the third detection light,
the second optical detection unit receives the fourth detection light,
the third optical detection unit receives the fifth detection light, and
the fourth optical detection unit receives the sixth detection light.

6. The film thickness measurement device according to claim 1, wherein a number of the at least one optical splitting unit, a number of the at least two optical filtering units and a number of the at least two optical detection units are determined according to a number of unknown values among film refractive index, film extinction coefficient and film thickness in ellipsometric parameters.

7. The film thickness measurement device according to claim 1, wherein the polarization state generator is a photoelastic modulator disposed corresponding to the light source, and the spectroscopic ellipsometer further comprises a lock-in amplifier coupled to the photoelastic modulator and the optical detector.

8. The film thickness measurement device according to claim 1, wherein the at least one optical splitting unit comprises at least one beam splitter mirror.

9. The film thickness measurement device according to claim 1, wherein the at least two optical filtering units comprises at least two band-pass filters.

10. The film thickness measurement device according to claim 1, wherein the at least two optical detection units comprises at least two photodiodes or photomultiplier tubes.
